(19) United States
(12) Patent Application Publication
(10) Pub. No.: US 2012/0159371 A1
(43) Pub. Date: Jun. 21, 2012

(54) RELATIVE-LOCATION MAPS BASED ON PERSONALIZED POINTS OF REFERENCE

(76) Inventors: Haley Thrapp, Champaign, IL (US); Scott E. Preece, Champaign, IL (US); Kendall Thrapp, Champaign, IL (US)

(21) Appl. No.: 12/969,121

(22) Filed: Dec. 15, 2010

(51) Int. Cl. G06F 3/048

(52) U.S. Cl. 715/772

(57) ABSTRACT

A user-specified personal point of reference provides a basis of orientation information for a geographic location. The orientation information associated with a geographic location is relative to the one or more user-specified personal points of reference. A personal point of reference can be specific to a user and can be shared by two or more users. Orientation information can comprise one or more display indicators, such as and without limitation one or more visual indicators, textual indicators, etc. Orientation information can comprise at least one indicator of distance, and can include other indicators, such as without limitation indicators of direction and/or travel time. The one or more visual or display indicators can be provided in a user interface display in response to a search request by a user.

### FIELD

The present disclosure relates to using personalized points of reference in a mapping application, and more specifically to a method and system for relating map locations to one or more user-specified personal points of reference.

### RELATED ART

A mapping application typically displays a map of a geographic area in a display at a user computer. A difficulty that the user has, particularly in a case that the user is unfamiliar with some or all of the geographic area, is orienting a location shown in the mapped area, e.g., a point of interest, an address, etc., relative to the user's own frame of reference. There is no guarantee that a location known to the user will be within the geographic area displayed by the mapping application. Even in a case that a location familiar to the user is within the displayed geographic area, conventional mapping applications are limited in their ability to provide information to allow the user to relate a map location to a location that is known to the user.

Additionally, a conventional mapping application does not, and cannot, identify a distance between locations without specific input from the user after the map is displayed and the user requests a “directions” option. A user unfamiliar with the mapping application may not know that the “directions” option can be used to identify a distance between two locations. Additionally, once the user selects the “directions” option, and the application prompts the user to enter one or more of the locations for which the directions are needed, the user using a conventional mapping application must then enter information, e.g., address, to identify one or more of the locations before the application outputs the directions with distance information. Additionally, the output is limited to providing the directions after the user selects the “directions” option between the two locations specified by the user for the “directions” option.

### SUMMARY

The present disclosure seeks to address these needs and others. By way of introductions, the present disclosure allows an application, such as a mapping application, to take advantage of multiple locations that the user has expressed interest in to provide orientation information relative to one or more of the user's locations. Such locations are referred to as personal points of reference specific to the user. By way of one non-limiting example, orientation information, e.g., visual indicator indicating a distance between a first location and at least one personal point of reference, icons, etc., is provided to an application, e.g., a mapping application, for display in a user interface display, such as a display that includes a map of a geographic area including the first location. By way of another non-limiting example, the orientation information can include a visual indicator of the travel time between the first location and at least one personal point of reference.

In accordance with one or more embodiments, a user-specified personal point of reference provides a basis for geographic location orientation information. An application can use one or more user-specified locations as personal points of reference to provide orientation information for a geographic location, e.g., a search result item's geographic location. The orientation information associated with a geographic location is relative to the one or more user-specified personal points of reference. A personal point of reference can be shared by two or more users. By way of one non-limiting example, orientation information can comprise one or more graphical indicators, such as icons, textual indicators, etc. Orientation information can comprise at least one visual indicator of distance, and can include other indicators, such as without limitation indicators of direction. By way of another non-limiting example, the orientation information can include a visual indicator of the travel time between the first location and at least one personal point of reference. The one or more visual or display indicators can be provided in a user interface display in response to a search request by a user.

In a first aspect, in accordance with one or more embodiments, a method is provided by at least one computing device to search, in response to a user's search request, a database comprising one or more personal points of reference associated with the user, each personal point of reference having an associated geographic location, the user's search request resulting in at least one search result item that has an associated geographic location; select at least one personal point of reference from the database for the user; generate, for each selected personal point of reference, orientation information for the search result item's geographic location relative to the personal point of reference's geographic location; facilitate serving a response to the user's search request, the response including a display page containing at least one visual indicator of the search result item's orientation information relative to each selected personal point of reference.

In another aspect, a system is provided, the system comprises at least one processor executing and memory storing instructions to search, in response to a user's search request, a database comprising one or more personal points of reference associated with the user, each personal point of reference having an associated geographic location, the user's search request resulting in at least one search result item that has an associated geographic location; select at least one personal point of reference from the database for the user; generate, for each selected personal point of reference, orientation information for the search result item's geographic location relative to the personal point of reference's geographic location; facilitate serving a response to the user's search request, the response including a display page containing at least one visual indicator of the search result item's orientation information relative to each selected personal point of reference.

In yet another aspect, a computer readable storage medium for tangibly storing thereon computer readable instructions that when executed cause at least one processor to search, in response to a user's search request, a database comprising one or more personal points of reference associated with the user, each personal point of reference having an associated geographic location, the user's search request resulting in at least one search result item that has an associated geographic location; select at least one personal point of reference from the database for the user; generate, for each selected personal point of reference, orientation information for the search result item's geographic location relative to the personal point of reference's geographic location; facilitate serving a response to the user's search request, the response including a display page containing at least one visual indicator of the search result item's orientation information relative to each selected personal point of reference.

In accordance with one or more aspects, a system is provided that comprises one or more computing devices configured to provide functionality in accordance with such aspects. Functionality is embodied in steps of a method performed by at least one computing device. Program code to implement functionality in accordance with one or more aspects is embodied in, by and/or on a computer-readable medium.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 illustrates components of an exemplary system in accordance with one or more embodiments of the present disclosure.

FIG. 2 illustrates a process flow in accordance with one or more embodiments of the present disclosure.

FIG. 3 provides an example of a web page including orientation information in accordance with one or more embodiments of the present disclosure.

FIGS. 4, 5, and 6 provide additional examples of orientation information presented in a user interface in accordance with one or more embodiments of the present disclosure.

FIG. 7, which comprises FIGS. 7A and 7B, illustrate a sequence for saving a personal point of reference location in accordance with one or more embodiments of the present disclosure.

FIG. 8 is an exemplary system diagram illustrating component interaction in accordance with one or more embodiments of the present disclosure.

FIG. 9 is a detailed block diagram illustrating an internal architecture of a computing device in accordance with one or more embodiments of the present disclosure.

### DETAILED DESCRIPTION

In general, the present disclosure includes a system, method and architecture for using personalized points of reference as basis for orientation information for one or more search result item geographic locations, e.g., information such as distance and/or travel time information. Certain embodiments of the present disclosure will now be discussed with reference to the aforementioned figures, wherein like reference numerals refer to like components.

Various embodiments are disclosed herein; however, it is to be understood that the disclosed embodiments are merely illustrative of the disclosure that can be embodied in various forms. In addition, each of the examples given in connection with the various embodiments is intended to be illustrative, and not restrictive. Further, the figures are not necessarily to scale, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

The present invention is described below with reference to block diagrams and operational illustrations of methods and devices to select personal points of reference of a user to provide orientation information for a requested mapping location relative to the selected personal points of reference. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

The principles described herein may be embodied in many different forms. The described systems and methods allow orientation information to be provided or served via a network, such as the Internet, in connection with a display provided in response to a search request, e.g., a display including map content of a requested geographic location. The orientation information for the requested geographic location is relative to the one or more user-specified personal points of reference. Personal points of reference are locations of interest to a user, and are not exclusively confined to a user's home or geo-coded current location. The personal points of reference also include other locations for which the user has expressed interest. For example, locations where the user vacations, owns property, has family, etc. The locations can be predefined by the user, or input in real-time.

The personal points of reference may be stored within a user profile. In accordance with one or more embodiments, each personal point of reference corresponds to a geographic location, e.g., a user's saved location(s). Data, or metadata associated with a saved location can include without limitation a name, a nickname, geographic coordinates, street address and/or entities associated with the location. It should be apparent that other data can be associated with a saved location without departing from the scope of the present disclosure. In one or more embodiments, the data associated with a saved location can be stored in a user profile and/or in other databases. In accordance with one or more such embodiments, saved locations stored within the user profile may only contain partial location information. This is beneficial as it saves space within the user profile.

As discussed above, orientation information for a requested geographic location is provided based on one or more personal points of reference for a user. The personal points of reference correspond to saved locations of interest of the user, and can include saved locations specified by other users and shared with the user. In accordance with one or more embodiments, all of the user's personal points of reference can be used to provide relative orientation information for a requested geographic location. Alternatively, each saved location identified for the user can undergo a filtering process to determine whether or not to use the saved location as a personal point of reference for the user. By way of one non-limiting example, a saved location can be excluded, or not selected, based on whether or not the saved location falls within a map area that is to be served to the user in response to the user's request for map content. As yet another alternative, an option can be provided to the user to select which of the user's saved locations are to be used to as personal points of reference for purposes of providing the relative orientation information.

In accordance with one or more embodiments, each personal point of reference can be used to provide orientation information for a given geographic location, e.g., a geographic location associated with a search result item. For each personal point of reference selected, orientation information for the given geographic location is determined relative to the selected personal point of reference using their respective geographic locations, which can be expressed as geographic coordinates such as Global Positioning System (GPS) coordinates. The orientation information can comprise a determined distance between the given geographic location and a selected personal point of reference. The determined distance can be included as text, e.g., in a table, that is displayed in a page returned to the user in response to the user's request. By way of some non-limiting examples, the distance can be a walking distance, a driving distance, flying distance, nautical distance, etc. By way of another non-limiting example, the orientation information can include a visual indicator of the travel time between the first location and at least one personal point of reference. Optionally and in addition to distance and/or travel time information, an icon representing the given geographic location and the selected personal point of reference can be displayed in map content to represent the location, and direction, of the requested geographic location relative to the selected personal point of reference.

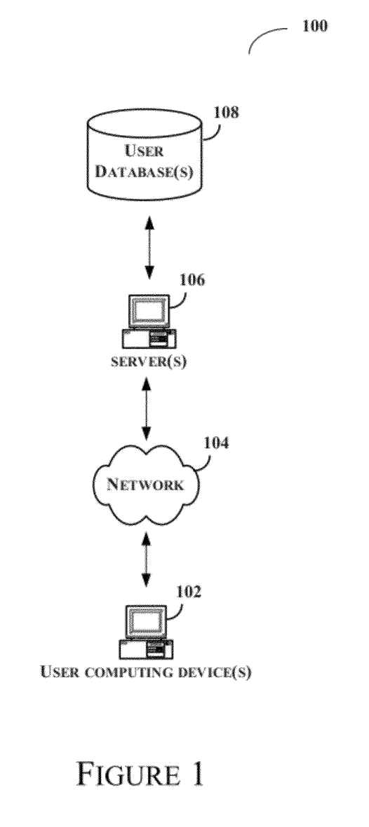

One or more embodiments will now be described in greater detail with reference to the figures. In general, with reference to FIG. 1, a system 100 in accordance with an embodiment for providing orientation information is shown. The user can access a web page provided by web server 106 from a user computing device 102. The web page can be, for example, a web page in which the user requests map content, or inputs a search request, directed to an application executing on server 106. As is discussed in more detail below, user computing device 102 can be executing a front end application, and server 106 can be executing a backend application.

In accordance with one or more embodiments, the web page can include an area that displays map content, such as a web page containing a requested geographic location provided by web server 106 in response to the user's request for map content. Orientation information may be served to user computing device 102 via server 106. Each of user computing device 102 and web server 106 can be communicatively coupled via a network 104, such as the Internet. Server 106 can be executing one or more applications, including without limitation a map application, a search application, a restaurant review site, etc.

While embodiments of the present disclosure are described with reference to a user interface including one or more web pages displayed using a user browser application, it should be apparent that any user interface is contemplated for use, e.g., in displaying orientation information, in accordance with embodiments of the present disclosure.

There may be multiple instances of server 106 and/or user computing device 102. At least one server 106 includes functionality to access user database 108, which stores a user's saved locations, or personal points of reference. In addition to a user's saved personal points of reference, other data may be stored in user database 108, including without limitation metadata, such as location name, e.g., “Chicago”, or domain, e.g., “marathons”. A server 106 may control access to the user database 108 by other servers 106, as well as user access. Server 106 may provide a facility that allows users to share some or all of the stored information with another user or an application executed by a server 106. The facility may attach authentication information, such as one or more of a username and/or password to a user profile, to authenticate an access request. The security can be at the user profile level, or at another level, such as by location, domain, etc.

User computing device 102 includes a scriptable web browser, such as Internet Explorer®, Netscape Navigator®, Mozilla®, Google Chrome®, Mozilla FireFox® or Opera®, or other program for interfacing with the network 104. The web server 106 provides web pages which are accessible by the user computing device 102. In accordance with one or more embodiments, a web page served by server 106 includes the orientation information for a requested geographic location relative to one or more personal points of reference defined for the user. Such a web page may contain portions written in Hypertext Markup Language (HTML), Extensible Markup Language (XML), Macromedia Flash, Java, JavaScript, and the like, as is generally known in the art.

It is to be understood that the present disclosure may be implemented utilizing any number of computer technologies. For example, although certain embodiments relate to providing access to content via the Internet, the disclosure may be utilized over any computer network, including, for example, a wide area network, local area network or, corporate intranet. Similarly, the user computing device 102 may be any computing device that may be coupled to the network, including, for example, personal digital assistants, web enabled cellular telephones, hard-wired telephones that dial into the network, mobile computers, personal computers, Internet appliances, wireless communication devices and the like. Furthermore, the servers described herein may be of any type, running any software, and the software modules, objects or plug-ins may be written in any suitable programming language.

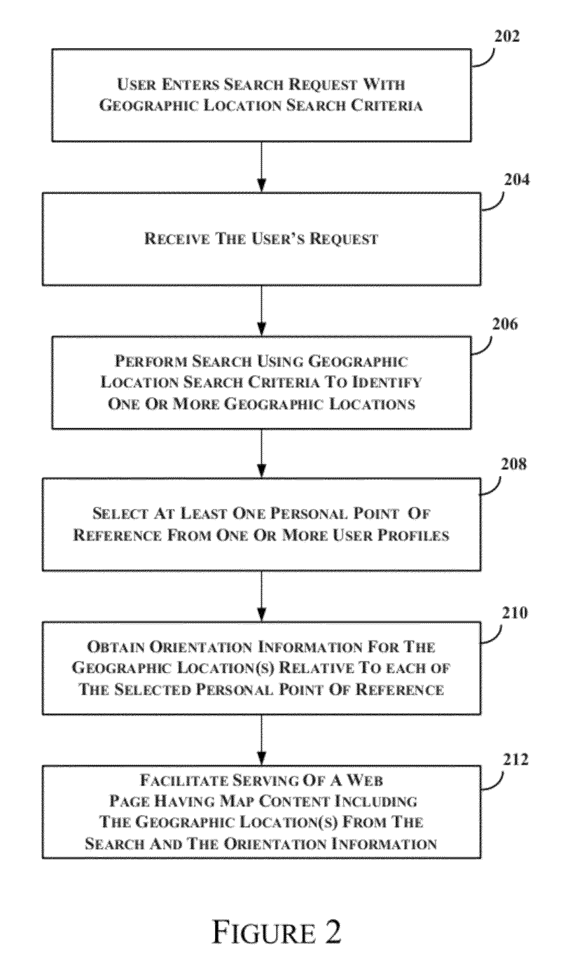

Having described components of the system 100, a general operation is described with reference to FIG. 2. At step 202, a user enters a search request. By way of some non-limiting example, the search request can be input to an application, such as a search application, map application, restaurant review application, residing at the user's computing device 102, at one or more of servers 106, or some combination of user computing device 102 and server(s) 106. By way of a further non-limiting example, the request can be generated by the user searching for a content page via a search engine, e.g., yahoo.com or one of its properties, e.g., mapping, shopping, travel, etc. The request may be generated by the user entering a geographic location in an input field of a browser. In some embodiments, appended to the user request is identifying information that the web server utilizes to access the user database for user-specific saved locations stored within the user database 106. In one or more embodiments, the user may login via a login ID provided at a user interface, which can result in identifying information being stored, e.g., in a cookie, on the user computing device 102. Identification information for the user enables the system to select saved locations as personal points of reference for the user. Additionally and without limitation, the user may provide information used in selecting a subset of the personal points of reference.

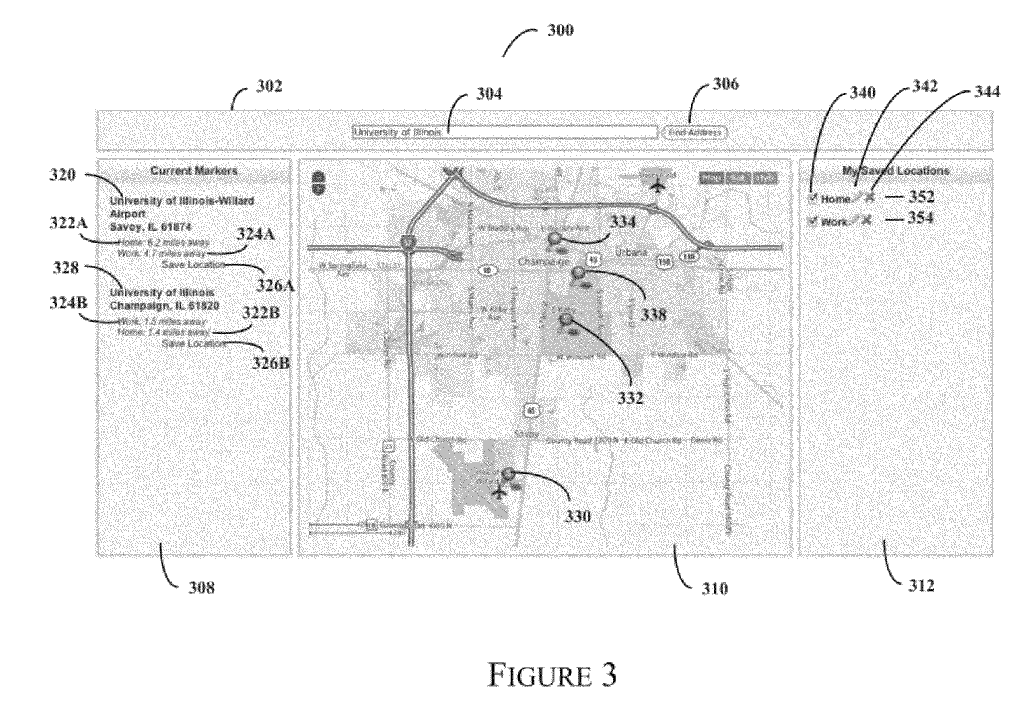

FIG. 3 provides an example of a web page including orientation information in accordance with one or more embodiments of the present disclosure. Area 302 of user interface display screen 300 includes an input field 304 for entering search criteria, e.g., a location such as “University of Illinois”, and a button 306 to submit a request to find the address that includes the search criteria entered by the user in field 304. In the example shown by display 300, an area 312 displays entries 352 and 354 corresponding to the user's saved locations retrieved from user database 108. In accordance with one or more embodiments, two or more users can share some or all of their personal points of reference. In such a case, area 312 can include saved locations associated with a plurality of users. Area 312 includes a check box for each saved locations that is to be used as a personal point of reference, which allows the user to select or de-select the corresponding saved location as a personal point of reference for inclusion in areas 308 and 310, as is discussed in more detail below. In accordance with one or more embodiments, the user can edit the information associated with the corresponding saved location by selecting icon 342, or delete the corresponding saved location by selected icon 344.

Referring to area 308 of display 300, the area provides a listing of result items returned from the search conducted using the search criteria entered in field 304 of area 302. Items 320 and 328 are the result items identified from the search. In addition to the result items, area 308 includes orientation information for each result item relative to the saved locations used as personal points of reference for the user, e.g., the saved locations listed in area 312 in this example. In the example shown in FIG. 3, the orientation information includes text indicating a distance and/or travel time between the search result item and each of the personal points of reference. Orientation information 322A and 322B corresponds to a “Home” personal point of reference, e.g., the user's home, which corresponds to display item 352 in area 312, and orientation information 324A and 324B corresponds to a “Work” personal point of reference, e.g., the user's work place, which corresponds to display item 354 in area 312.

Additionally and in accordance with one or more embodiments, map area 310 of display 300 provides orientation information. Map area 310 includes a visual indicator, e.g., an icon, indicating a location of each of search result items 320 and 328, as well as a visual indicator indicating a location of each personal point of reference. The visual indicators in map area 310 provide further orientation information, e.g., distance, travel time and/or direction, for the search result items relative to the user's personal points of reference. In the example, area 310 displays a map of a geographic area that includes result items 320, 328, and the selected personal points of reference, e.g., the user's “Home” and “Work” locations, and places pin icons representing the location of each on the map in area 310 in their relative locations. Pins 330 and 338 correspond to result items 320 and 328, respectively, and pins 332 and 334 correspond to the user's “Home” and “Work” personal points of reference, respectively. The user can remove one or both of pins 332 and 334 by removing the check in check box 340 for either or both of items 352 and 354 in area 312.

Area 308 of display 300 includes “Save Location” selections 326A and 326B, which correspond to search result items 320 and 328, respectively. The “Save Location” selection allows the user to save the search result item as a saved location for use as a personal point of reference. By way of some non-limiting examples, in response to choosing selection 326A or 326B, the user can be provided with a display that allows the user to specify data, or metadata, for the saved location, including without limitation a name and/or nickname for the saved location, set sharing rights, and/or specify selection criteria to be used in determining whether or not to use the saved location as a personal point of reference, e.g., criteria for use at step 208 of FIG. 2.

Referring again to FIG. 2, at step 204, the user's request, e.g., the search request entered in field 304 of FIG. 3, is transmitted from computing device 102, and directed to server 106, e.g., a mapping application, or other application executing on server 106. Upon receipt of the request, at step 206, the server performs a search using the search criteria from the request to identify one or more search result items, e.g., geographic locations that satisfy geographic location search criteria from the user's request. At step 208, the server accesses user database 108 to identify at least one personal point of reference for the user, e.g., from saved locations in the user's user profile and/or in a “shared” user profile of another user.

In accordance with one or more embodiments disclosed herein, a server selects one or more personal points of reference based on user preference, e.g., a user's preference expressed via a user interface, such as in area 312 of the page display shown in FIG. 3, or predefined selection criteria, such as selecting all saved locations that fall within a map area that contains the search result item(s). It should be apparent that any criteria or scheme can be used to select saved locations as personal points of reference. By way of some further non-limiting examples, saved locations can be selected to be personal points of reference based on the current time of the day, day of the week, etc., the user's current location, the application used to enter the search criteria, etc.

At step 210, orientation information is generated in accordance with each search result items and the selected personal points of reference. In accordance with one or more embodiments, each search result item and each personal point of reference has corresponding geographic coordinates, e.g., GPS coordinates. A distance can be computed between each search result item and each personal point of reference using their geographic coordinates. The distance can be a walking distance, driving distance, etc., and can be computed using any distance algorithm now known or later developed. In accordance with one or more embodiments, a distance filter can be used to determine whether or not to remove a personal point of reference based on the computed distance between the personal point of reference and a result item and a distance threshold, e.g., to eliminate a personal point of reference that is beyond the distance threshold from one, more than one, or all of the search result items. By way of a non-limiting example, travel time can be determined for a given route based on the distance as well as other conditions and/or factors, such as without limitation traffic, speed limit, actual and/or estimated speed, weather, etc.

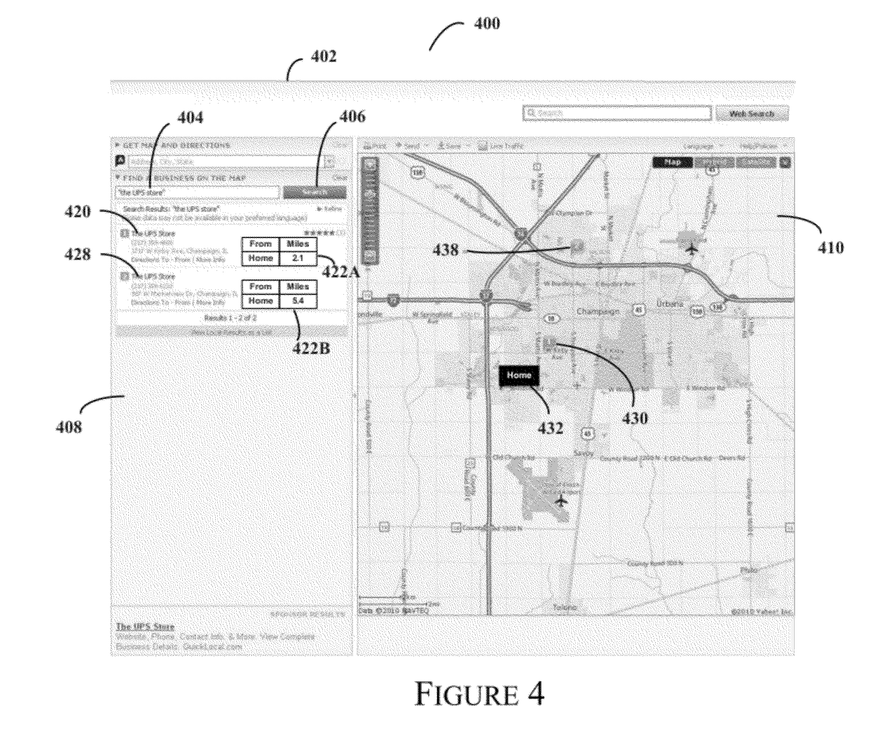

In accordance with one or more embodiments, orientation information includes information identifying each selected personal point of reference and the distance and/or travel time between the selected personal point of reference and a search result item. Additionally and in accordance with one or more embodiments, the orientation information is provided to the user using one or more visual display indicators, which can include an icon in the map content corresponding to each of the selected personal points of reference that represents the location of the selected personal point of reference relative to the search result item(s) and text indicating the determined distance(s) and/or travel time(s). Other examples of orientation information presented in a user interface are possible, including without limitation the examples discussed below in connections with FIGS. 4-6.

At step 212, a content page, e.g., a content page including a map area, result item(s), and orientation information for each search result item relative to the selected personal points of reference are delivered to the user device. The elements of the content page can be generated for display on a page prior to delivery to the user, or they can be used to generate a display page at the user computing device 102 by the web browser.

FIGS. 4-6 provide other examples of a web page including orientation information in accordance with one or more embodiments of the present disclosure. FIGS. 4-6 show various options around displaying distances between a personal point of reference and a search result item. In the examples shown in FIG. 4-6, the user has entered “The UPS Store” for search criteria on a map of Champaign, Ill. While it is not shown, it should be apparent that travel times can be displayed in place of or in addition to distances. In response, a display page is provided, which includes two result flags on the map (“1” and “2”). The map includes an additional flag corresponding to a personal point of reference corresponding to the saved location “Home”. As with FIG. 3, FIGS. 4-6 are examples; it should be apparent that other techniques for displaying orientation information are possible without departing from the scope of the embodiments of the present disclosure. Additionally, it should be apparent that various features from FIGS. 3-6 can be combined, for example and without limitation, the “Save Location” option and area 312 can be used in combination with the features shown in FIGS. 4-6.

In the example of display 400 provided in FIG. 4, orientation information is provided in the form of a table for each search result item, which shows the distance to a personal point of reference corresponding to the “Home” saved location. It should be apparent that the table can contain travel time information in addition to or in place of the distance information. Of course, if there were multiple personal points of reference, the tables would have additional lines for each personal point of reference. Area 402 includes a field for entering a web search, area 408 includes search result items 420 and 428, as well as fields 404 and 406 for entering and submitting geographic search criteria. Display area 408 further includes display items 422A and 422B, which correspond to result items 420 and 428 (respectively); each of which contain orientation information for a selected personal point of reference, e.g., “Home” saved location, and indicate a distance between the corresponding search result item and the personal point of reference. Additionally, in map area 410, different icons are used to differentiate between the search result items, icons 420 and 428 match the respective icons used with search result items 420 and 428 in the search result listing in area 408. The icon used for the personal point of reference includes the name, e.g., a nickname, for the personal point of reference, which visually differentiates the personal point of reference from the search result items' icons, and provides a correlation with the tables 422A and 422B in area 408.

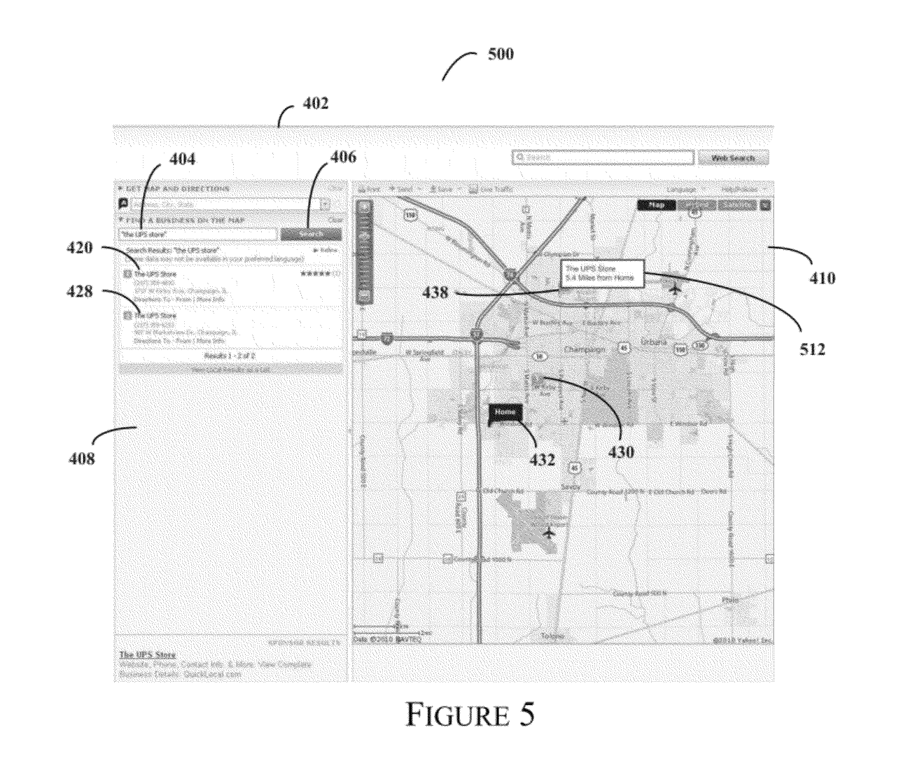

In the example of display 500 provided in FIG. 5, orientation information is displayed in a pop-up dialog 512 in response to the user using a mouse, or other pointing device, to position the cursor (not shown) over one of the icons, e.g., icons corresponding to search result items 420 and 428 in area 408 or icons 430 and 438 in area 410. The pop-dialog 512 includes the distance between a search result item selected by the user, e.g., the search result item hovered over by the cursor, and each personal point of reference. It should be apparent that pop-up dialog box could be displayed in response to hovering the mouse over icon 432, e.g., the dialog would include the distances between “Home” and each of the search result items 420 and 428. In accordance with one or more embodiments, dialog 512 is displayed while the cursor is positioned over the icon. While distance information is displayed in dialog 512, it should be apparent that information, such as without limitation travel time information, can be displayed in addition to or in place of the distance information.

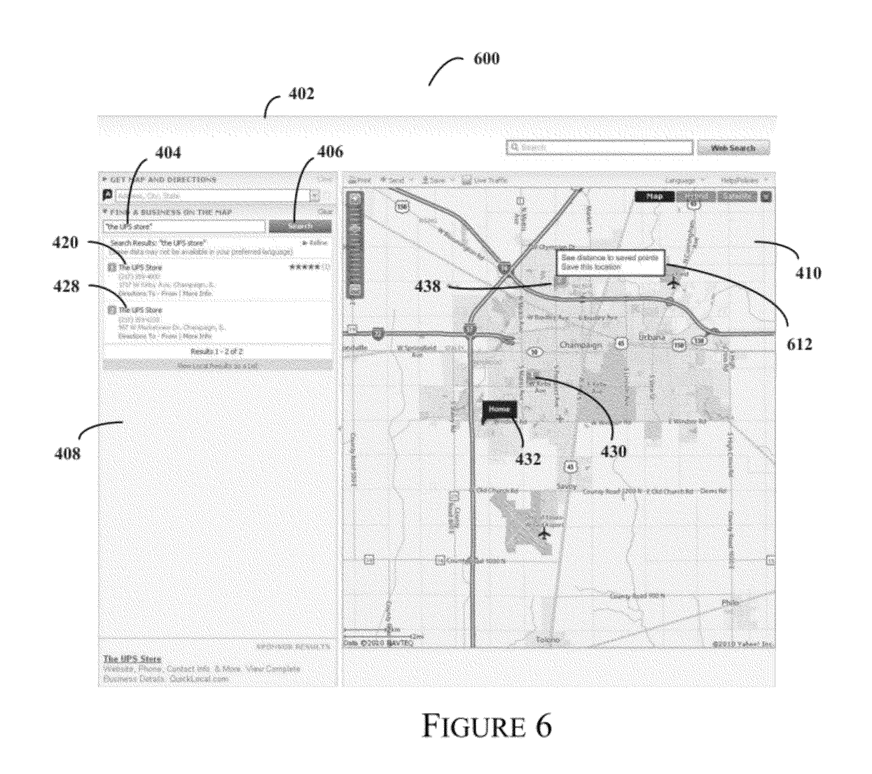

In the example of display 600 provided in FIG. 6, a pop-up menu 612 can be provided in response to the user right-clicking, e.g., pressing the right button on the mouse, while position the cursor (not shown) over an icon. In the example, the pop-up menu 612 includes options to see the distances (which could be shown as in dialog 512 of FIG. 5), or to save the location as a saved location. It should be apparent that pop-up dialog menu 612 could be displayed in response to positioning the cursor over icon 432, e.g., which would provide an option to view the distances between “Home” and each of the search result items 420 and 428, as well as an option to edit the “Home” point of reference and/or remove the point of reference from the user profile and/or the display 600. In accordance with one or more embodiments, dialog 612 can include an option to view travel times.

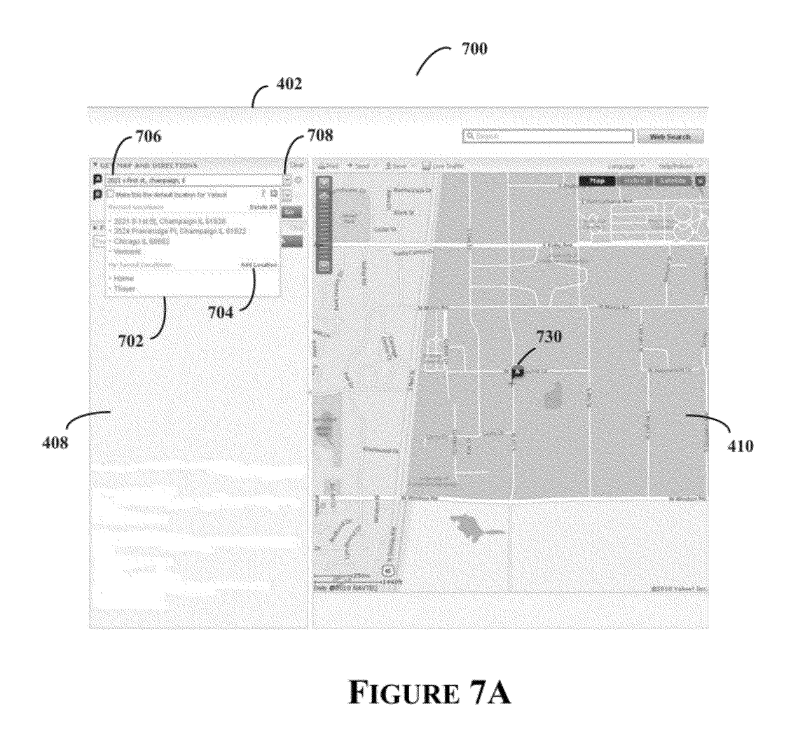

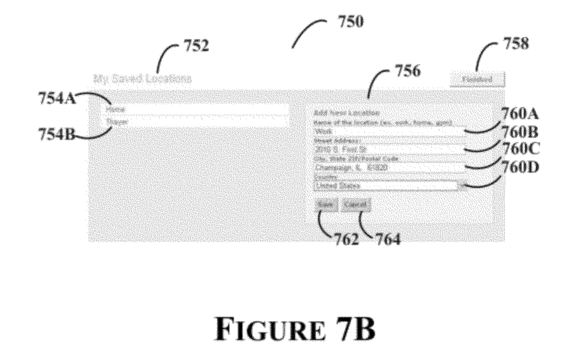

In accordance with one or more embodiments, a user can save a geographic location, and use the saved geographic location as a personal point of reference. As discussed above, a user can save one or more search result items as a geographic location that can be used as a personal point of reference. Additionally, a user can save search criteria with a geographic location, which can be used as a personal point of reference. FIGS. 7A and 7B provide an example of a save sequence with operations used in saving a location and other information associated with the location as a saved location, which saved location can be used as a point of reference in accordance with one or more embodiments. While the example shown illustrates saving a geographic location search criteria, it should be apparent that the exemplary sequence can be used to save any geographic location for use as a personal point of reference. By way of a non-limiting example, the sequence could be invoked in response to the user selecting the “Save this location” option in dialog menu 612, or selecting one of “Save Location” options 326A and 326B in display 300 of FIG. 3.

Display 700 of FIG. 7A includes area 402 with a search criteria input field and submit button, and map area 410, as in FIGS. 4-6. In the example shown in FIG. 7A, the user has entered a location in field 706 and selected down arrow icon 708, resulting in dialog 702 being displayed in area 408. Additionally, entry of the location in field 706 results in icon 730 being displayed in a map displayed in map area 410. Dialog 702 includes an “Add Location” option 704.

The user's selection of the “Add Location” option 704 results in the dialog 750 of FIG. 7B being displayed. In accordance with one or more embodiments, fields 760A-760D in area 756 of dialog 750 can initially include the geographic location information entered by the user in field 706, and the user can modify the information. Field 760A allows the user to enter a name or nickname for the location that can be displayed as part of a visual indicator, e.g., such as is discussed above with reference to FIGS. 3-6. Area 752 of dialog 750 includes a listing of saved locations, e.g., entries 754A and 754B identified with their respective names retrieved from the user database 108. The user can save the new location using the “Save” button 762 or cancel the operation using the “Cancel” button 764. The user can close the dialog 750 using the “Finished” button 758.

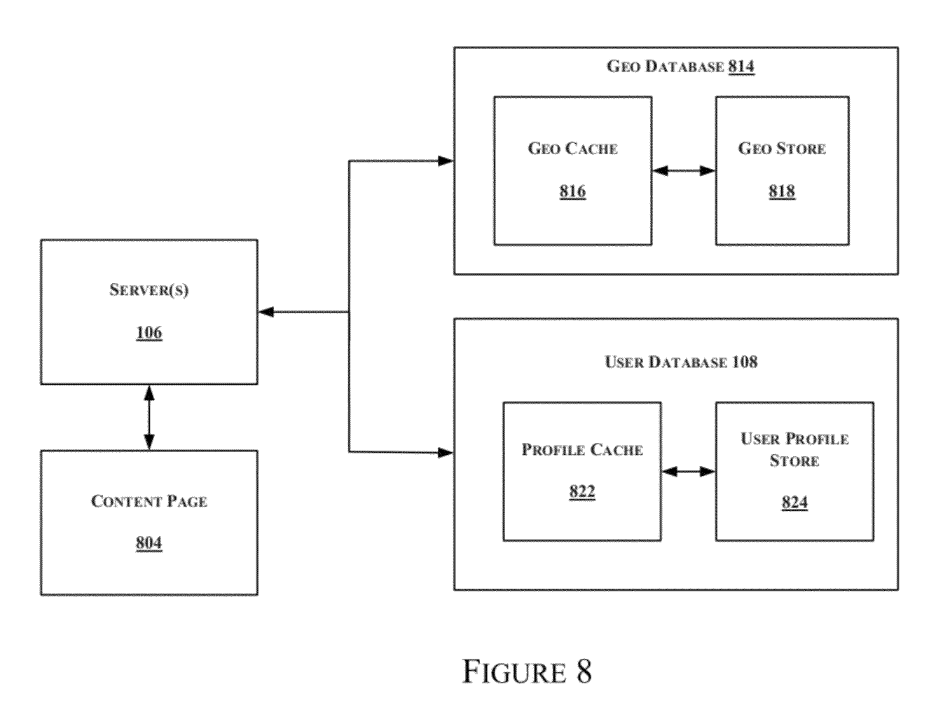

FIG. 8 is an exemplary system diagram illustrating the entities that the server 106 interacts with in order to retrieve the content page and the user's personal points of reference, and ultimately serve the map content with orientation information in accordance with one or more embodiments. The server 106 executes a mapping application, or other application, that is in communication with geographic database 814 and user database 108. The server 106 performs a search of geographic database 814 for at least one geographic location based on search criteria received from the user, and searches the user database 108 for the saved location to use as personal points of reference for the user.

In accordance with one or more embodiments, the content page 804 includes at least one search result item having a geographic location, at least one personal point of reference and orientation information for the at least one geographic location relative to the at least one personal point of reference.

The user database 108 provides the requesting server 106 with saved locations that can be used as personal points of reference, e.g., the user's saved locations and optionally one or more other users' saved locations shared with the user. As discussed herein, personal points of reference are locations of interest to a user, e.g., saved locations. The saved locations can include a user's home or geo-coded current location (for mobile devices), and other locations for which the user has expressed interest. For example, locations where the user vacations, owns property, has family, or even a location that the user would like to research.

The user database 108 comprises a profile cache 822 and a user profile store 824. According to exemplary embodiments, the user profile store 824 stores a user's saved locations. In accordance with one or more embodiments, profile cache 822 comprises a temporary store of saved locations, and is optional in at least one embodiment. By way of a non-limiting example, profile cache 822 contains locations that have been retrieved in the past. It is more likely that a location that has been retrieved in the past is of certain particular interest to a user. Thus, the profile cache 822 can house this information in order to expedite retrieval time and decrease latency.

Personal points of reference are represented by a location “name”, which can be retrieved from user profile store 824 along with a corresponding geographic location. In accordance with one or more embodiments, the profile cache 824 may store the GPS location of a geographic location, e.g., latitude and longitude coordinates, or other coordinate or location specification. The saved locations within the user profile store 824 can either take the standard name, or a user can rename a location in order to personalize the location. For example, if a user normally vacations in Miami, Fla., the user may want to denote the location as “Vacation” instead of the leaving a generic location name as “Miami, Fla.”.

In certain embodiments, the profile cache 822 and/or user profile store 824 can store a portion of the location information associated with a geographic location that can be used to retrieve additional location information as needed. This is beneficial as it saves space within the user database 108 and lowers transmission and retrieval time. By way of a non-limiting example, information that is available in geographic database 814 need not be saved in user database 108. By way of a non-limiting example, GPS coordinates and street address might be saved in geographic database 814 along with a unique identifier or key; and the unique identifier/key can be associated with a geographic location in user database 108 and used to retrieve a geographic location's information from geographic database 814. User database 108 can also be used to store user-defined information for a geographic location.

With reference to FIG. 2 in connection with FIG. 8, steps 204, 206, 208, 210 and 212 of FIG. 2 can be performed by one or more servers 108 to facilitate serving of content page 804. In accordance with one or more embodiments, at step 204, server 106 receives the search request from a user. By way of a non-limiting example, the search request can be directed to a mapping application executing on server 108. By way of another non-limiting example, the search request can be directed to a restaurant, theatre etc. review or guide application. Embodiments of the present disclosure can be used in connection with any current or later developed application to provide orientation information for a geographic location relative to a personal point of reference associated with one or more users. The server 106 configured with one or more such applications uses geographic location information contained in the search request, or geographic location information identified using information contained in the user's request, to query geographic database 108 for search results including one or more geographic locations.

The search request received at step 204 of FIG. 2 can include user identification information or the user identification information can be retrieved from storage, e.g., a cookie resident on the user computing device 102. Server 106 queries user database 108 to retrieve the user's locations as the user's personal points of reference. If the user has sharing privileges with one or more other users, server 106 can retrieve one or more saved locations from the other user(s). Server 106 may perform a filtering to filter out saved locations, e.g., to exclude saved locations that the user has excluded from consideration, exclude saved locations that fall outside the extents of mapping content to be displayed in content page 804, etc.

Server 106 uses the geographic location, e.g., GPS coordinates, of each search result item retrieved from the geographic database 814 and the geographic location of each unfiltered personal point of reference retrieved from the user database query 108 to generate the orientation information including a distance and/or travel time between each search result item's geographic location and each personal point of reference's geographic location. It should be apparent that any computation algorithm, module, component, program, code, etc. now known or later developed can be used to determine distance and/or travel time without departing from the scope of the present disclosure. In accordance with one or more embodiments, a second filtering can be performed to exclude personal points of reference that exceed a threshold distance or travel time from some or all of the search result items. In accordance with one or more embodiments, the extents of the mapping content can be determined based on one or more of the search result items, the unfiltered personal points of reference, available space within content page 804, network bandwidth considerations, etc. In accordance with one or more embodiments, in a case that content page 804 includes mapping content, server 106 can cause placement of an icon at the geographic location in the map content in content page 804 of each of search result item and personal point of reference. Server 106 causes content page 804 to be served to user computing device 102.

Embodiments of the present disclosure have been described in which content page 804 includes map content that includes visual indicators, e.g., icons, text, pop-up dialogs, etc. of orientation, which may be combined with indicators, e.g., textual or other indicators of orientation, provided in at least one other area of content page 804, e.g., area 408. It should be apparent that orientation information can be provided without map content, or conversely without the at least one other area, without departing from the scope of present disclosure.

In accordance with one or more embodiments, a front-end and backend application configuration can be used. The front-end application can reside on the user computing device 102 and facilitate user interaction, and the backend application can reside on one or more of servers 106 with responsibility to store the user's saved locations and associated data, e.g., metadata, and provide access to the saved locations and associated data for the user. The front end application can present a variety of interfaces, such as a web page or other user interface. Using the user interface provided by the front end application, the user can save a new location, input a search, and/or see orientation information, e.g., distance and/or travel time tables for search result item locations including orientation information relative to one or more personal points of reference.

In accordance with at least one embodiment, in a case that the user interface comprises one or more web pages, the front end can comprise a plugin and/or addon to the user's browser application at client computing device 102, and the plugin/addon allows the user to display the web page using their browser. The plugin/addon can be aware of the user's saved locations, can be responsible for parsing pages as they are loaded in the browser, and can enable the interaction with addresses. By way of one non-limiting example and in accordance with at least one embodiment, the browser plugin/addon can be used by the user to interact with any address on the page to cause a page to be displayed that includes visual indicators associated with the address and one or more of saved locations associated with the user. In accordance with one or more embodiments, a right click interaction with an icon displayed on the map and representing the address causes an indicator, e.g., a visual display indicator such as a textual and/or graphical indicator, to be displayed thereby allowing the user to quickly get the distance and/or travel time from the address to one or more of the saved locations used as personal points of interest associated with the user.

In accordance with one or more embodiments, the frontend application can be invoked by an external application, such as a search application or a restaurant-review site. By way of one non-limiting example, the user can use the external application to search for gyms associated with a particular zip code, for example, and a map is returned in response; the map shows all of the search result items, gyms in this example, and their distances and/or travel times from the user's saved points of reference. By way of another non-limiting example, a user visiting a restaurant review web site can input a search to the web site, and a web page is returned in response, which presents search result items, e.g., restaurants and the user's personal points of reference, as pin icons on a map, together with text indicating the distance and/or travel time between each search result item and each point of reference.

In accordance with one or more embodiments, the front end application can be installed on a mobile device, and can integrate the user's current location and show distances and/or travel times from that location to saved location or a search result item or search criteria, and can also allow the user to save the current location as a new saved location.

In accordance with one or more embodiments, users can have saved locations in multiple cities, and can filter saved locations using different modes. By way of one non-limiting example, the frontend application can offer a choice of “nearby” mode, which shows saved locations near a searched address or the current location, a “locale” mode, which shows saved locations tagged with a particular locale or domain, and/or “global” mode, which shows saved locations on a map large enough to encompass the saved locations. In the absence of a mode selection, the application can apply heuristics to select the set of saved locations convenient to a given search.

In accordance with one or more embodiments, the front-end application can facilitate controlling the sharing of points of reference of a plurality of users. By way of some non-limiting examples, a group of users planning a tour could share a set of reference points around the hotels the tour would be using, or a conference planner could create a list of reference points around the conference facility and make it available to attendees.

In accordance with one or more embodiments, the backend application, or service, which can execute on one or more of servers 106, provides a facility for storing the user's saved locations and associating metadata with a saved location, such as location name, “locale” information, domain information, etc. In accordance with at least one embodiment, the facility can be a shared facility that associates sets of stored data with multiple users, with an appropriate security mechanism to control access to each user's individual data. In accordance with one or more embodiments, the backend service comprises a service to interface with other services and/or applications to provide controlled access to the user's saved locations; the saved locations being accessible from any of a number of applications, including without limitation any location-based applications and/or map-oriented application. Access may include various kinds of searching based on the stored data, or metadata, associated with a saved location.

Generally, computing device such as server 106 can serve content to user computing device 102 using a browser application via a network 104. A computing device can be any computing device, including without limitation a personal computer, personal digital assistant (PDA), wireless device, cell phone, internet appliance, media player, home theater system, and media center, or the like. For the purposes of this disclosure a computing device includes a processor and memory for storing and executing program code, data and software, and may be provided with an operating system that allows the execution of software applications in order to manipulate data. A computing device can include one or more processors, memory, a removable media reader, network interface, display and interface, and one or more input devices, e.g., keyboard, keypad, mouse, etc. and input device interface, for example. One skilled in the art will recognize that a computing device may be configured in many different ways and implemented using many different combinations of hardware, software, or firmware.

In accordance with one or more embodiments, a server computing device can make a user interface available to a client computing, e.g., a user computing device, via the network. The user interface made available to the client computing device can include content items, or identifiers (e.g., URLs) selected for the user interface based on usefulness prediction(s) generated in accordance with one or more embodiments of the present disclosure. In accordance with one or more embodiments, a server computing device can make a user interface available to a client computing device by communicating a definition of the user interface to the client computer device via one or more networks. The user interface definition can be specified using any of a number of languages, including without limitation a markup language such as Hypertext Markup Language, scripts, applets and the like. The user interface definition can be processed by an application executing on the client computing device, such as a browser application, to output the user interface on a display coupled, e.g., a display directly or indirectly connected, to the client computing device.

In an embodiment the network may be the Internet, an intranet (a private version of the Internet), or any other type of network. An intranet is a computer network allowing data transfer between computing devices on the network. Such a network may comprise personal computers, mainframes, servers, network-enabled hard drives, and any other computing device capable of connecting to other computing devices via an intranet. An intranet uses the same Internet protocol suit as the Internet. Two of the most important elements in the suit are the transmission control protocol (TCP) and the Internet protocol (IP).

It should be apparent that embodiments of the present disclosure can be implemented in a client-server environment. Alternatively, embodiments of the present disclosure can be implemented other environments, e.g., a peer-to-peer environment as one non-limiting example.

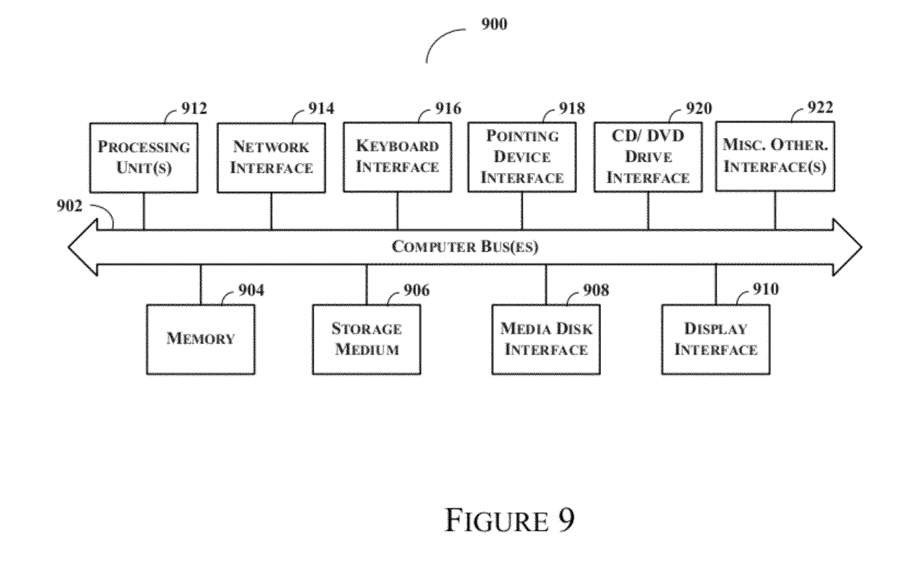

FIG. 9 is a detailed block diagram illustrating an internal architecture of a computing device, e.g., a computing device such as server 902 or user computer 904, in accordance with one or more embodiments of the present disclosure. As shown in FIG. 9, internal architecture 900 includes one or more processing units, processors, or processing cores, (also referred to herein as CPUs) 912, which interface with at least one computer bus 902. Also interfacing with computer bus 902 are computer-readable medium, or media, 906, network interface 914, memory 904, e.g., random access memory (RAM), run-time transient memory, read only memory (ROM), etc., media disk drive interface 908 as an interface for a drive that can read and/or write to media including removable media such as floppy, CD-ROM, DVD, etc. media, display interface 910 as interface for a monitor or other display device, keyboard interface 916 as interface for a keyboard, pointing device interface 918 as an interface for a mouse or other pointing device, and miscellaneous other interfaces not shown individually, such as parallel and serial port interfaces, a universal serial bus (USB) interface, and the like.

Memory 904 interfaces with computer bus 902 so as to provide information stored in memory 904 to CPU 912 during execution of software programs such as an operating system, application programs, device drivers, and software modules that comprise program code, and/or computer-executable process steps, incorporating functionality described herein, e.g., one or more of process flows described herein. CPU 912 first loads computer-executable process steps from storage, e.g., memory 904, computer-readable storage medium/media 906, removable media drive, and/or other storage device. CPU 912 can then execute the stored process steps in order to execute the loaded computer-executable process steps. Stored data, e.g., data stored by a storage device, can be accessed by CPU 912 during the execution of computer-executable process steps.

Persistent storage, e.g., medium/media 906, can be used to store an operating system and one or more application programs. Persistent storage can also be used to store device drivers, such as one or more of a digital camera driver, monitor driver, printer driver, scanner driver, or other device drivers, web pages, content files, playlists and other files. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method comprising:
searching, via a computing device in response to a user's search request, a database comprising one or more personal points of reference associated with the user, each personal point of reference having an associated geographic location, the user's search request resulting in at least one search result item that has an associated geographic location;
selecting, via the computing device, at least one personal point of reference from the database for the user;
generating, via the computing device for each selected personal point of reference, orientation information for the search result item's geographic location relative to the personal point of reference's geographic location;
facilitating serving, via the computing device, a response to the user's search request, the response including a display page containing at least one visual indicator of the search result item's orientation information relative to each selected personal point of reference.

2. The method of claim 1, the search result item's orientation information relative to a selected personal point of reference comprising a distance between the search result item's geographic location and the personal point of reference's geographic location.

3. The method of claim 2, the display page comprising map content, the at least one visual indicator of the search result item's orientation information relative to each selected personal point of reference comprising a visual indictor indicating the search result item's geographic location within the map content and a visual indicator for each selected personal point of reference indicating the personal point of reference's geographic location within the map content.

4. The method of claim 3, the at least one visual indicator having associated text, the method further comprising:
identifying, via the at least one server using received user input, a selected visual indicator, the received user input indicating that the user's mouse is positioned over the selected visual indicator; and
causing to be displayed, via the at least one server at the user's computing device, the text associated with the selected visual indicator in proximity to the selected visual indicator while the user input indicates that the user's mouse is positioned over the selected visual indicator.

5. The method of claim 4, the selected visual indicator is the visual indicator indicating the search result item's geographic location within the map content, and the text specifies, for each personal point of reference, the distance between the search result's geographic location and the personal point of reference's geographic location.

6. The method of claim 5, the selected visual indicator is the visual indicator indicating the search result item's geographic location within the map content, and the text includes a selectable option to store the search result item as a new personal point of reference for the user.

7. The method of claim 5, the selected visual indicator is the visual indicator indicating the search result item's geographic location within the map content, and the text includes a selectable option to display, for each personal point of reference, the distance between the search result's geographic location and the personal point of reference's geographic location.

8. The method of claim 1, the one or more personal points of reference associated with the user comprises at least one personal point of reference specified by the user and at least one other personal point of reference, the at least one other personal point of reference being specified by another user, the other user specifying in the database that the at least one other personal is to be shared with the user.

9. A system comprising:
at least one computing device comprising one or more processors to execute and memory to store instructions to:
search, in response to a user's search request, a database comprising one or more personal points of reference associated with the user, each personal point of reference having an associated geographic location, the user's search request resulting in at least one search result item that has an associated geographic location;
select at least one personal point of reference from the database for the user;
generate, for each selected personal point of reference, orientation information for the search result item's geographic location relative to the personal point of reference's geographic location;
facilitate serving a response to the user's search request, the response including a display page containing at least one visual indicator of the search result item's orientation information relative to each selected personal point of reference.

10. The system of claim 9, the search result item's orientation information relative to a selected personal point of reference comprising a distance between the search result item's geographic location and the personal point of reference's geographic location.

11. The system of claim 10, the display page comprising map content, the at least one visual indicator of the search result item's orientation information relative to each selected personal point of reference comprising a visual indictor indicating the search result item's geographic location within the map content and a visual indicator for each selected personal point of reference indicating the personal point of reference's geographic location within the map content.

12. The system of claim 11, the at least one visual indicator having associated text, the instructions further comprising instructions to:
identify, using received user input, a selected visual indicator, the received user input indicating that the user's mouse is positioned over the selected visual indicator; and
cause to be displayed, at the user's computing device, the text associated with the selected visual indicator in proximity to the selected visual indicator while the user input indicates that the user's mouse is positioned over the selected visual indicator.

13. The system of claim 12, the selected visual indicator is the visual indicator indicating the search result item's geographic location within the map content, and the text specifies, for each personal point of reference, the distance between the search result's geographic location and the personal point of reference's geographic location.

14. The system of claim 13, the selected visual indicator is the visual indicator indicating the search result item's geographic location within the map content, and the text includes a selectable option to display, for each personal point of reference, the distance between the search result's geographic location and the personal point of reference's geographic location.

15. A computer readable storage medium for tangibly storing thereon computer readable instructions that when executed cause at least one processor to:
search, in response to a user's search request, a database comprising one or more personal points of reference associated with the user, each personal point of reference having an associated geographic location, the user's search request resulting in at least one search result item that has an associated geographic location;
select at least one personal point of reference from the database for the user;
generate, for each selected personal point of reference, orientation information for the search result item's geographic location relative to the personal point of reference's geographic location;
facilitate serving a response to the user's search request, the response including a display page containing at least one visual indicator of the search result item's orientation information relative to each selected personal point of reference.

16. The medium of claim 15, the search result item's orientation information relative to a selected personal point of reference comprising a distance between the search result item's geographic location and the personal point of reference's geographic location.

17. The medium of claim 16, the display page comprising map content, the at least one visual indicator of the search result item's orientation information relative to each selected personal point of reference comprising a visual indictor indicating the search result item's geographic location within the map content and a visual indicator for each selected personal point of reference indicating the personal point of reference's geographic location within the map content.

18. The medium of claim 17, the at least one visual indicator having associated text, the instructions further comprising instructions to:
identify, using received user input, a selected visual indicator, the received user input indicating that the user's mouse is positioned over the selected visual indicator; and
cause to be displayed, at the user's computing device, the text associated with the selected visual indicator in proximity to the selected visual indicator while the user input indicates that the user's mouse is positioned over the selected visual indicator.

19. The medium of claim 18, the selected visual indicator is the visual indicator indicating the search result item's geographic location within the map content, and the text specifies, for each personal point of reference, the distance between the search result's geographic location and the personal point of reference's geographic location.

20. The medium of claim 19, the selected visual indicator is the visual indicator indicating the search result item's geographic location within the map content, and the text includes a selectable option to display, for each personal point of reference, the distance between the search result's geographic location and the personal point of reference's geographic location.
